(19) United States
(12) Patent Application Publication
(10) Pub. No.: US 2016/0305712 A1
(43) Pub. Date: Oct. 20, 2016

(54) HEAT-SHIELDED CONDUIT

(71) Applicant: UNITED TECHNOLOGIES CORPORATION, Farmington, CT (US)

(72) Inventor: Meggan Harris, Colchestser, CT (US)

(73) Assignee: UNITED TECHNOLOGIES CORPORATION, Farmington, CT (US)

(21) Appl. No.: 15/101,810

(22) PCT Filed: Dec. 9, 2014
(86) PCT No.: PCT/US2014/069284

§ 371 Date: Jun. 3, 2016

Related U.S. Application Data
(60) Provisional application No. 61/915,076, filed on Dec. 12, 2013.

(51) Int. Cl. F28D 7/10; B23P 15/26

(52) U.S. Cl. CPC F28D 7/10; B23P 15/26

(57) ABSTRACT

A heat-shielded conduit includes a tube, a heat shield, and a truss structure. The tube has a tube inner diameter and a tube outer diameter. The heat shield radially surrounds the tube. The heat shield has a shield inner diameter greater than the tube outer diameter to form a first gap between the heat shield and the tube. The truss structure is integrally formed together with both of the tube and the heat shield to space the shield inner diameter from the tube outer diameter and maintain the first gap.

### BACKGROUND

The present invention relates to conduits for carrying fluids, such as fuel or oil, in gas turbine engines, and in particular to heat-shielded conduits. Conduits, such as fuel lines, or oil lines, may need to pass through hot regions of a gas turbine engine. When exposed to heat, hydrocarbons, such as jet fuel or oil, may form carbonaceous deposits on inside surfaces of the fuel or oil lines. The deposits may accumulate to the point where they restrict the flow of fuel or oil, resulting in damage or operational failure of a portion of the gas turbine engine.

Fuel or oil lines in gas turbine engines typically have a foil insulation wrapped around the exterior of the line to insulate the line and shield the fluid in the line from exposure to heat. Installation and maintenance of such heat shielding can be costly. In addition, such heat shielding is not always as effective as desired, requiring additional, costly measures to insure the lines remain clear of deposits. A more effective and more economical heat-shielded conduit is desired.

### SUMMARY

An embodiment of the present invention is a conduit for carrying a fluid. The conduit includes a tube, a heat shield, and a truss structure. The tube has a tube inner diameter and a tube outer diameter. The heat shield radially surrounds the tube. The heat shield has a shield inner diameter greater than the tube outer diameter to form a first gap between the heat shield and the tube. The truss structure is integrally formed together with both of the tube and the heat shield to space the shield inner diameter from the tube outer diameter and maintain the first gap.

Another embodiment of the present invention is a method for making a heat-shielded conduit. The method includes building the heat-shielded conduit by a layer-by-layer additive manufacturing process. The method also includes forming, while building the heat-shielded conduit, a tube and a heat shield radially surrounding the tube. The method includes integrally forming a truss structure together with both of the tube and the heat shield to space the heat shield from the tube and maintain a first gap between the heat shield and the tube.

### BRIEF DESCRIPTION OF THE DRAWINGS

FIG. 1 is a perspective view of a heat-shielded conduit.

FIG. 2 is a side cross-sectional view of the heat-shielded conduit of FIG. 1.

FIG. 3 is a side cross-sectional view of a heat-shielded conduit in which a diameter of the tube decreases along a length of the conduit for increasing fluid flow velocity within the tube along the length of the conduit.

FIG. 4 is a side cross-sectional view of a heat-shielded conduit in which a diameter of the tube decreases along a first length of the conduit; and the diameter of the tube increases along a second length of the conduit.

FIG. 5 is a side cross-sectional view of a heat-shielded conduit in which a gap decreases along a length of the conduit for increasing cooling fluid flow velocity within the gap along the length of the conduit.

FIG. 6 is a side cross-sectional view of a heat-shielded conduit in which a gap decreases along a first length of the conduit, and the gap increases along a second length of the conduit.

FIG. 7 is a side cross-sectional view of a heat-shielded conduit including a fitting.

### DETAILED DESCRIPTION

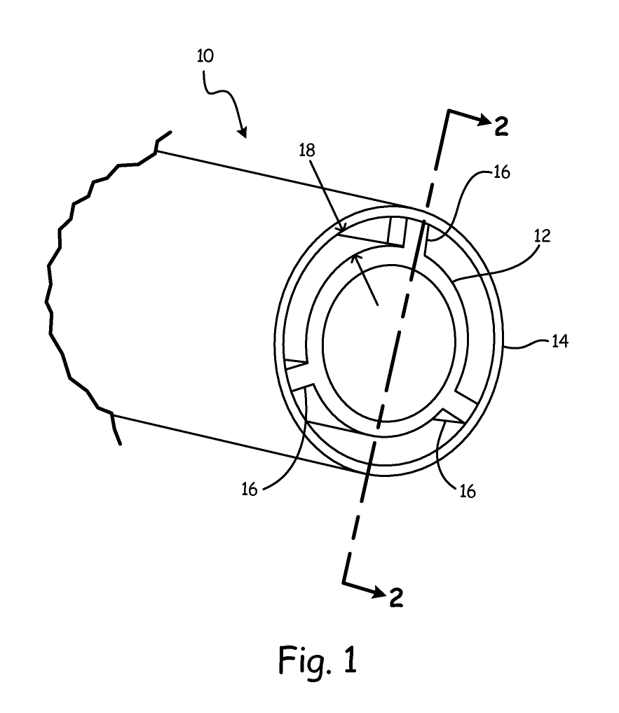

FIG. 1 is a perspective cross-sectional view of a portion of heat-shielded conduit. As shown in FIG. 1, conduit 10 includes tube 12, heat shield 14, and truss structure 16. Heat shield 14 radially surrounds tube 12 to form first gap 18. Truss structure 16 is formed integrally with tube 12 and heat shield 14 such that conduit 10 is a one-piece structure. Truss structure 16 spaces heat shield 14 from tube 12 to maintain first gap 18.

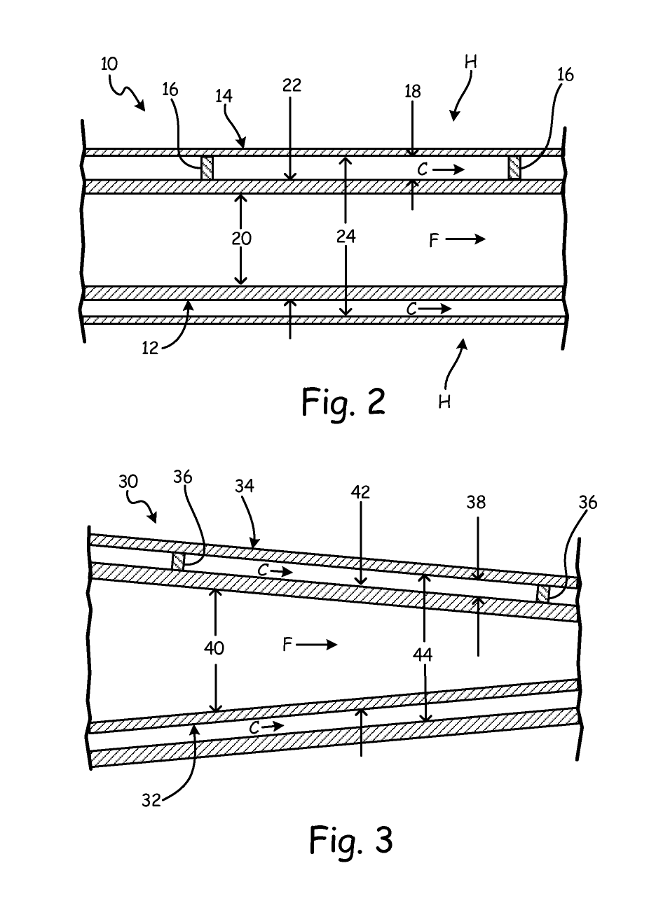

FIG. 2 is a side cross-sectional view of the heat-shielded conduit of FIG. 1. As shown in FIG. 2, tube 12 includes tube inner diameter 20 and tube outer diameter 22. Heat shield 14 includes shield inner diameter 24. In the embodiment of FIG. 2, tube inner diameter 20 does not vary along a length of conduit 10. Tube outer diameter 22 and shield inner diameter 24 also do not vary along the length of conduit 10, thus first gap 18 does not vary along the length of conduit 10.

Considering FIGS. 1 and 2 together, in operation, fluid F flows through tube 12 of conduit 10, bounded by tube inner diameter 20. Heat shield 14 and first gap 18 shield tube 12 from heat external to conduit 10. First gap 18 may contain another fluid, such as air, that is a poor conductor of heat to slow the transfer of heat from heat shield 14 to tube 12.

In the embodiment shown in FIG. 1, truss structure 16 includes a plurality of rectilinear spokes spaced circumferentially around tube 12 and extending radially between heat shield 14 and tube 12. Alternatively, truss structure 16 may include a plurality of round or square pillars, arcuate segments, or similar structures spacing heat shield 14 from tube 12 to maintain first gap 18. Truss structure 16 is not necessarily a poor conductor of heat, but, by design, it covers a relatively small area between heat shield 14 and tube 12, and thus contributes little to an overall transfer of heat to tube 12.

The fluid in first gap 18 may be static, or may be a flow of cooling fluid C as shown in FIG. 2. Cooling fluid C flowing through first gap 18 carries much of external heat H absorbed by heat shield 14 away from heat shield 14 and out of conduit 10 before it reaches tube 12. Truss structure 16 does not significantly impede the flow of cooling fluid C through gap 18. This feature permits conduit 10 to operate under more extreme external heat conditions. FIG. 2 shows cooling fluid C flowing in the same direction as fluid F, which may be the case if the source of fluid F and the source of cooling fluid C are located at the same end of conduit 10. However, it is understood that cooling fluid C and fluid F may flow counter-currently for enhanced heat transfer efficiency.

Conduit 10 is able to provide more effective heat shielding than prior art insulated lines, eliminating or reducing deposit build-up in tube 12. Installation and maintenance costs are much lower because tube 12, heat shield 14, and truss structure 16 are integrally formed together by additive manufacturing processes, as described further below. Thus, conduit 10 may be installed as a single piece, requiring little, if any, additional maintenance.

FIG. 3 is a side cross-sectional view of another embodiment of a heat-shielded conduit. As shown in FIG. 3, conduit 30 includes tube 32, heat shield 34, and truss structure 36. Heat shield 34 radially surrounds tube 32 to form first gap 38. Truss structure 36 is identical to truss structure 16 described above, and is formed integrally with tube 32 and heat shield 34 such that conduit 30 is a one-piece structure. Tube 32 includes tube inner diameter 40 and tube outer diameter 42. Heat shield 34 includes shield inner diameter 44. In the embodiment of FIG. 3, tube inner diameter 40 varies along a length of conduit 30 for varying fluid flow velocity of fluid F within tube 32 along the length of conduit 30. Tube outer diameter 42 and shield inner diameter 44 vary correspondingly with tube inner diameter 40 along the length of conduit 30; thus first gap 38 does not vary along the length of conduit 30. This embodiment may be employed, for example, under conditions where heat external to conduit 30 increases along the length of conduit 30 and increasing the fluid flow velocity of fluid F reduces the time spent in a portion of conduit 30 exposed to the increased heat.

While the embodiment of FIG. 3 illustrates the case in which tube inner diameter 40 decreases along a length of conduit 30 for increasing fluid flow velocity of fluid F within tube 32 along the length of conduit 30, it is understood that by symmetry, the present invention encompasses embodiments in which tube inner diameter 40 increases along a length of conduit 30 for decreasing fluid flow velocity of fluid F within tube 32 along the length of conduit 30. This could be accomplished merely by reversing the direction of flow of fluid F in tube 32.

FIG. 4 is a side cross-sectional view of another embodiment of a heat-shielded conduit. As shown in FIG. 4, conduit 50 includes tube 52, heat shield 54, and truss structure 56. Heat shield 54 radially surrounds tube 52 to form first gap 58. Truss structure 56 is identical to truss structure 16 described above, and is formed integrally with tube 52 and heat shield 54 such that conduit 50 is a one-piece structure. Tube 52 includes tube inner diameter 60 and tube outer diameter 62. Heat shield 54 includes shield inner diameter 64. In the embodiment of FIG. 4, tube inner diameter 60 decreases along first length 65 of conduit 50 for increasing fluid flow velocity of fluid F within tube 52 along first length 65. Tube inner diameter 60 also increases along second length 66 of conduit 50 for decreasing fluid flow velocity of fluid F within tube 52 along second length 66. Tube outer diameter 62 and shield inner diameter 64 vary correspondingly with tube inner diameter 60 along the length of conduit 50, thus first gap 58 does not vary along the length of conduit 50. This embodiment may be employed, for example, under conditions where heat external to conduit 50 is at a maximum between first length 65 and second length 66 and increasing the fluid flow velocity of fluid F reduces the time spent in a portion of conduit 30 exposed to the maximum heat.

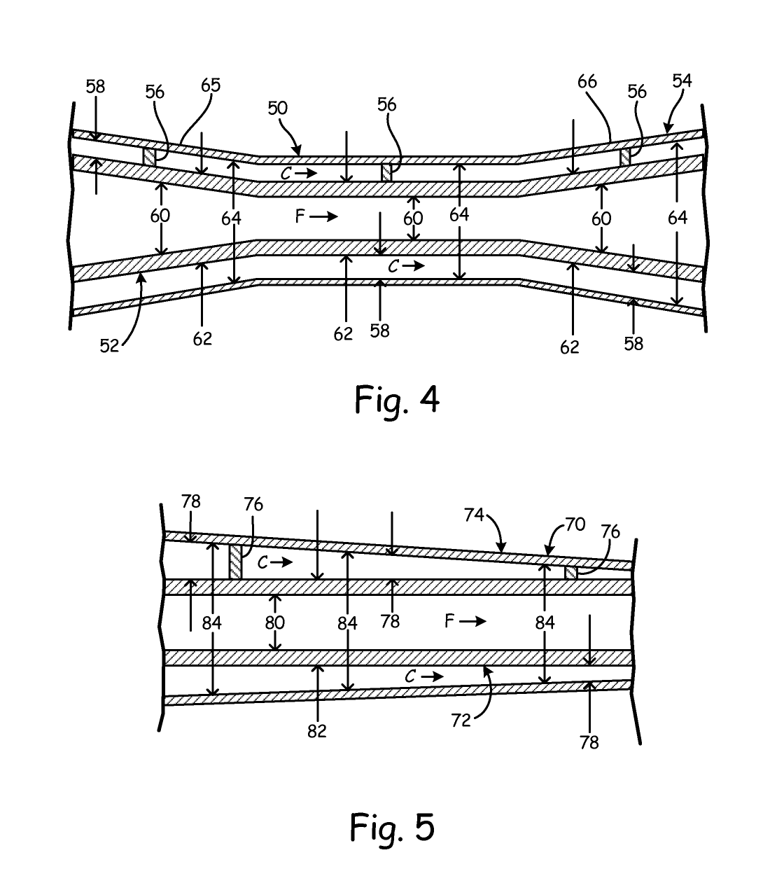

FIG. 5 is a side cross-sectional view of another embodiment of a heat-shielded conduit. As shown in FIG. 5, conduit 70 includes tube 72, heat shield 74, and truss structure 76. Heat shield 74 radially surrounds tube 72 to form first gap 78. Truss structure 76 is formed integrally with tube 72 and heat shield 74 such that conduit 70 is a one-piece structure. Tube 72 includes tube inner diameter 80 and tube outer diameter 82. Heat shield 74 includes shield inner diameter 84. In the embodiment of FIG. 5, neither tube inner diameter 80 nor tube outer diameter 82 vary along a length of conduit 70. Shield inner diameter 84 does vary along the length of conduit 70. Thus, first gap 78, formed between heat shield 74 and tube 72, also varies along the length of conduit 70 for varying the flow velocity of cooling fluid C within first gap 78 along the length of conduit 70. This embodiment may be employed, for example, under conditions where heat external to conduit 70 increases along the length of conduit 70 and increasing the fluid flow velocity of cooling fluid C increases the speed and efficiency at which heat is removed along a portion of conduit 70 exposed to the increased heat.

While the embodiment of FIG. 5 illustrates the case in which first gap 78 decreases along a length of conduit 70 for increasing the fluid flow velocity of cooling fluid C within first gap 78 along the length of conduit 70, it is understood that by symmetry, the present invention encompasses embodiments in which first gap 78 increases along a length of conduit 70 for decreasing the fluid flow velocity of cooling fluid C within first gap 78 along the length of conduit 70. This could be accomplished merely by reversing the flow direction of cooling fluid C in first gap 78.

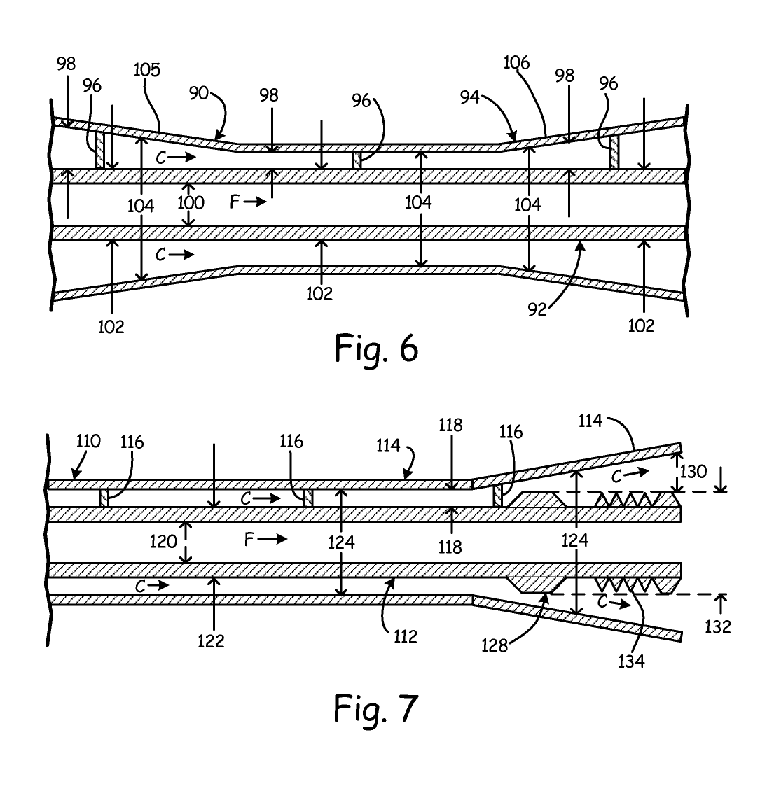

FIG. 6 is a side cross-sectional view of another embodiment of a heat-shielded conduit. As shown in FIG. 6, conduit 90 includes tube 92, heat shield 94, and truss structure 96. Heat shield 94 radially surrounds tube 92 to form first gap 98. Truss structure 96 is identical to truss structure 76 described above, and is formed integrally with tube 92 and heat shield 94 such that conduit 90 is a one-piece structure. Tube 92 includes tube inner diameter 100 and tube outer diameter 102. Heat shield 94 includes shield inner diameter 104. In the embodiment of FIG. 6, neither tube inner diameter 100 nor tube outer diameter 102 vary along a length of conduit 90. Shield inner diameter 104 decreases along first length 105 of conduit 90 for increasing the flow velocity of cooling fluid C within first gap 98 along first length 105. Shield inner diameter 104 also increases along second length 106 of conduit 90 for decreasing the flow velocity of cooling fluid C within first gap 98 along second length 106. Thus, first gap 98, formed between heat shield 94 and tube 92, also varies along the length of conduit 90 for varying the flow velocity of cooling fluid C within first gap 98 along the length of conduit 90. This embodiment may be employed, for example, under conditions where heat external to conduit 90 is at a maximum between first length 105 and second length 106 and increasing the fluid flow velocity of cooling fluid C increases the speed and efficiency at which heat is removed along a portion of conduit 90 exposed to the increased heat.

FIG. 7 is a side cross-sectional view of another embodiment of a heat-shielded conduit. As shown in FIG. 7, conduit 110 includes tube 112, heat shield 114, truss structure 116, and fitting 128. Fitting 128 extends axially from tube 112 and is formed integrally with tube 112 at an end of conduit 110. Heat shield 114 radially surrounds tube 112 to form first gap 118. Heat shield 114 also radially surrounds at least a portion of fitting 128 to form second gap 130. Truss structure 116 is formed integrally with tube 112, heat shield 114, and fitting 128 such that conduit 110 is a one-piece structure. Tube 112 includes tube inner diameter 120 and tube outer diameter 122. Heat shield 114 includes shield inner diameter 124. Fitting 128 includes fitting outer diameter 132. Fitting 128 is shown as a threaded connector including threads 134. As an alternative to threads 134, fitting 128 may be a barbed connector.

In the embodiment of FIG. 7, truss structure 116 spaces heat shield 114 from fitting outer diameter 132 to maintain second gap 130, in addition to spacing heat shield 114 from tube 112 to maintain first gap 118. As with the embodiment described above in reference to FIG. 2, the fluid in first gap 118 and second gap 130 may be static, or may be a flow of cooling fluid C, as shown in FIG. 7. In this embodiment, first gap 118 is in flow communication with second gap 130, such that cooling fluid C flows through first gap 118 and then flows through second gap 130 to carry much of the external heat absorbed by heat shield 114 away from heat shield 114 and out of conduit 110 before it reaches either tube 112 or fitting 128. This feature permits conduit 110, including fitting 128, to operate under more extreme external heat conditions. Although FIG. 7 shows cooling fluid C flowing in the same direction as fluid F, the present invention encompasses embodiments in which cooling fluid C flows counter-currently for enhanced heat transfer efficiency. Also, it is understood that the present invention encompasses embodiments having fitting 128 at both ends of conduit 110, and heat shield 114 radially surrounding at least a portion of each fitting 128.

Additive manufacturing processes allow the complex geometries of the heat-shielded conduits described above in reference to FIGS. 1, 2, 3, 4, 5, 6, and 7 to be realized. An example of such an additive manufacturing process is described in U.S. patent application Ser. No. 13/869,042, “COMBUSTOR COMPONENT WITH COOLING HOLES FORMED BY ADDITIVE MANUFACTURING” assigned to United Technologies Corporation, incorporated herein by reference. For example, with reference to FIG. 2, to make conduit 10, tube 12 and heat shield 14 are integrally formed together as a stack of layers of material during an additive manufacturing process. Truss structure 16 is integrally formed with both tube 12 and heat shield 14 to space heat shield 14 from tube 12 and maintain first gap 18 between heat shield 14 and tube 12.

In another example, with reference to FIG. 7, to make conduit 110, tube 112, heat shield 114, and fitting 128 are integrally formed together as a stack of layers of material during an additive manufacturing process. Fitting 128 is formed extending axially from tube 114. Truss structure 116 is integrally formed with tube 112, heat shield 114 and fitting 128 to space heat shield 114 from tube 112 to maintain first gap 118, and to space heat shield 114 and from fitting 128 to maintain second gap 130. Threads 134 may also be formed integrally with fitting 128, or formed by machining after the additive manufacturing process.

The additive manufacturing process may include, for example, laser powder deposition or direct metal laser sintering. The heat-shielded conduits described above in reference to FIGS. 1, 2, 3, 4, 5, 6, and 7 may be made of a titanium alloy or a nickel-base alloy, for example, a high-temperature super alloy. The use of additive manufacturing eliminates the need for brazing or welding together individual components. As a result, significant cost savings are realized, both in labor, and in materials.

A heat-shielded conduit embodying the present invention provides for more effective heat shielding than prior art insulated lines. As a result, any accumulation of deposits in the conduit from exposure to heat may be reduced or eliminated. Installation and maintenance costs are much lower than prior art insulated lines because a tube, a heat shield, and a truss structure are integrally formed together by additive manufacturing to make the heat-shielded conduit. The heat-shielded conduit may be installed as a single piece, requiring little, if any, additional maintenance.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

The following are non-exclusive descriptions of possible embodiments of the present invention.

A conduit for carrying a fluid includes a tube, a heat shield, and a truss structure. The tube has a tube inner diameter and a tube outer diameter. The heat shield radially surrounds the tube. The heat shield has a shield inner diameter greater than the tube outer diameter to form a first gap between the heat shield and the tube. The truss structure is integrally formed together with both of the tube and the heat shield to space the shield inner diameter from the tube outer diameter and maintain the first gap.

The conduit of the preceding paragraph can optionally include, additionally and/or alternatively, any one or more of the following features, configurations, and/or additional components:

the tube inner diameter varies along a length of the conduit;

the tube inner diameter decreases along a length of the conduit for increasing fluid flow velocity within the tube along the length of the conduit;

the tube inner diameter increases along a length of the conduit for decreasing fluid flow velocity within the tube along the length of the conduit;

the tube inner diameter decreases along a first length of the conduit, and the tube inner diameter of the tube increases along a second length of the conduit;

the first gap varies along a length of the conduit;

the first gap is adapted to contain a flow of cooling fluid;

the first gap decreases along a length of the conduit for increasing cooling fluid flow velocity within the first gap along the length of the conduit;

the first gap increases along a length of the conduit for decreasing cooling fluid flow velocity within the first gap along the length of the conduit;

wherein the first gap decreases along a first length of the conduit for increasing cooling fluid flow velocity within the first gap along the first length of the conduit, and the first gap increases along a second length of the conduit for decreasing cooling fluid flow velocity within the first gap along the second length of the conduit;

the conduit further includes a fitting extending axially from the tube and integrally formed with the tube at an end of the conduit, and the heat shield radially surrounds at least a portion of the fitting and is spaced from the fitting by the truss structure to maintain a second gap between the heat shield and the fitting;

the fitting includes at least one of a barbed connector and a threaded connector;

the first gap and the second gap are in flow communication, and the first gap and second gap are adapted to contain a flow of cooling fluid;

the material is a sintered metal; and

the material is a nickel alloy.

A method for making a heat-shielded conduit includes building the heat-shielded conduit by a layer-by-layer additive manufacturing process. The method also includes forming, while building the heat-shielded conduit, a tube and a heat shield radially surrounding the tube. The method also includes integrally forming a truss structure together with both of the tube and the heat shield to space the heat shield from the tube and maintain a first gap between the heat shield and the tube.

The method of the preceding paragraph can optionally include, additionally and/or alternatively, any one or more of the following features, configurations, and/or additional components:

forming a fitting extending axially from the tube at an end of the conduit, and integrally forming the truss structure further includes forming the truss structure together with both of the fitting and the heat shield to space the heat shield from the fitting and maintain a second gap between the heat shield and the fitting;

the first gap and the second gap are in flow communication, and the first gap and second gap are adapted to contain a flow of cooling fluid;

forming a fitting includes at least one of forming a barbed connector and forming a threaded connector; and

additively manufacturing includes using at least one of laser powder deposition and direct metal laser sintering.

1. A conduit for carrying a fluid, the conduit comprising:
a tube having a tube inner diameter and a tube outer diameter;
a heat shield radially surrounding the tube, the heat shield having a shield inner diameter greater than the tube outer diameter to form a first gap between the heat shield and the tube; and
a truss structure integrally formed together with both of the tube and the heat shield to space the shield inner diameter from the tube outer diameter and maintain the first gap.

2. The conduit of claim 1, wherein the tube inner diameter varies along a length of the conduit.

3. The conduit of claim 2, wherein the tube inner diameter decreases along a length of the conduit for increasing fluid flow velocity within the tube along the length of the conduit.

4. The conduit of claim 2, wherein the tube inner diameter increases along a length of the conduit for decreasing fluid flow velocity within the tube along the length of the conduit.

5. The conduit of claim 2, wherein the tube inner diameter decreases along a first length of the conduit; and the tube inner diameter of the tube increases along a second length of the conduit.

6. The conduit of claim 1, wherein the first gap varies along a length of the conduit.

7. The conduit of claim 6, wherein the first gap is adapted to contain a flow of cooling fluid.

8. The conduit of claim 7, wherein the first gap decreases along a length of the conduit for increasing cooling fluid flow velocity within the first gap along the length of the conduit.

9. The conduit of claim 7, wherein the first gap increases along a length of the conduit for decreasing cooling fluid flow velocity within the first gap along the length of the conduit.

10. The conduit of claim 7, wherein the first gap decreases along a first length of the conduit for increasing cooling fluid flow velocity within the first gap along the first length of the conduit, and the first gap increases along a second length of the conduit for decreasing cooling fluid flow velocity within the first gap along the second length of the conduit.

11. The conduit of claim 1, further including:
a fitting extending axially from the tube and integrally formed with the tube at an end of the conduit;
wherein the heat shield radially surrounds at least a portion of the fitting and is spaced from the fitting by the truss structure to maintain a second gap between the heat shield and the fitting.

12. The conduit of claim 11, wherein the fitting includes at least one of a barbed connector and a threaded connector.

13. The conduit of claim 11, wherein the first gap and the second gap are in flow communication, and the first gap and second gap are adapted to contain a flow of cooling fluid.

14. The conduit of claim 1, wherein a material of the conduit is a sintered metal.

15. The conduit of claim 1, wherein a material of the conduit is a nickel alloy.

16. A method for making a heat-shielded conduit, the method comprising:
building the heat-shielded conduit by a layer-by-layer additive manufacturing process;
forming, while building the heat-shielded conduit, a tube and a heat shield radially surrounding the tube; and
integrally forming a truss structure together with both of the tube and the heat shield to space the heat shield from the tube and maintain a first gap between the heat shield and the tube.

17. The method of claim 16, further including:
forming a fitting extending axially from the tube at an end of the conduit; and
integrally forming the truss structure further includes forming the truss structure together with both of the fitting and the heat shield to space the heat shield from the fitting and maintain a second gap between the heat shield and the fitting.

18. The method of claim 17, wherein the first gap and the second gap are in flow communication, and the first gap and second gap are adapted to contain a flow of cooling fluid.

19. The method of claim 18, wherein forming a fitting includes at least one of forming a barbed connector and forming a threaded connector.

20. The method of claim 16, wherein additively manufacturing includes using at least one of laser powder deposition and direct metal laser sintering.
